(19) United States
(12) Patent Application Publication
(10) Pub. No.: US 2005/0130538 A1
(43) Pub. Date: Jun. 16, 2005

(54) Insulation containing a mixed layer of textile fibers and of rotary and/or flame attenuated fibers, and process for producing the same

(75) Inventors: Alain Yang, Bryn Mawr, PA (US); Gary Tripp, Corbin, KY (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Certainteed Corporation, Valley Forge, PA (US)

(21) Appl. No.: 11/049,692

(22) Filed: Feb. 4, 2005

Related U.S. Application Data
(63) Continuation of application No. 09/946,476, filed on Sep. 6, 2001.

(51) Int. Cl. B32B 1/04; B32B 5/24; B32B 5/18; D04H 13/00; D04H 5/00; D04H 3/00; D04H 1/00; B32B 17/04; B32B 17/02; B32B 3/02

(52) U.S. Cl. 442/331; 428/74; 442/180; 442/348

(57) ABSTRACT

An insulation product contains a mixed layer of textile fibers and of rotary and/or flame attenuated fibers. A process for manufacturing the insulation product includes passing fibrous bundles of textile fibers and of rotary and/or flame attenuated fibers together through an apparatus that divides the textile fibers into segments and that mixes the textile fiber segments with the rotary and/or flame attenuated fibers. The bundles of rotary and/or flame attenuated fibers can be in the form of specially manufactured mats and/or can be production scraps. The resulting mixture of fibers is formed into a non-woven batt, mat, blanket, or board. The process provides a mixed fiber product, with an improved combination of thermal and acoustic insulating performance and adequate strength, at a low production cost.

### BACKGROUND OF THE INVENTION

1. Field of the Invention

This invention relates to fiber insulation. More specifically, this invention relates to thermal and acoustic insulation containing a mixed layer of textile fibers and of rotary and/or flame attenuated fibers. This invention also relates to a process for manufacturing the mixed layer.

2. Description of the Background

Glass and polymer fiber mats positioned in the gap between two surfaces can be used to reduce the passage of heat and noise between the surfaces.

Heat passes between surfaces by conduction, convection and radiation. Because glass and polymer fibers are relatively low thermal conductivity materials, thermal conduction along glass and polymer fibers is minimal. Because the fibers slow or stop the circulation of air, mats of the fibers reduce thermal convection. Because fiber mats shield surfaces from direct radiation emanating from other surfaces, the fiber mats reduce radiative heat transfer. By reducing the conduction, convection and radiation of heat between surfaces, fiber mats provide thermal insulation.

Sound passes between surfaces as wave-like pressure variations in air. Because fibers scatter sound waves and cause partial destructive interference of the waves, a fiber mat attenuates noise passing between surfaces and provides acoustic insulation.

Conventional fiber mats or webs used for thermal and acoustic insulation are made either primarily from textile fibers, or from rotary or flame attenuated fibers. Textile fibers used in thermal and acoustic insulation are typically chopped into segments 2 to 15 cm long and have diameters of greater than 5 μm up to 16 μm. Rotary fibers and flame attenuated fibers are relatively short, with lengths on the order of 1 to 5 cm, and relatively fine, with diameters of 2 μm to 5 μm. Mats made from textile fibers tend to be stronger and less dusty than those made from rotary fibers or flame attenuated fibers, but are somewhat inferior in insulating properties. Mats made from rotary or flame attenuated fibers tend to have better thermal and acoustic insulation properties than those made from textile fibers, but are inferior in strength.

Conventional fiber insulation fails to provide a satisfactory combination of insulation and strength. Conventional fiber insulation also tends to be expensive. Especially in ductliner applications, a need exists for new, low cost, fiber products with an improved combination of insulation, strength and handling characteristics. Processes to produce these products are also needed.

### SUMMARY OF THE INVENTION

The present invention provides a fiber insulation product including a mixed layer of textile fibers and of rotary and/or flame attenuated fibers. The mixture of textile and of rotary and/or flame attenuated fibers in the mixed layer results in a low cost insulation product with superior thermal and acoustic insulation properties. The mixed layer can be formed by combining textile fibers and rotary and/or flame attenuated fibers, chopping the combined fibers together to mix and shorten the fibers, and then forming a mat from the mixed fibers.

### BRIEF DESCRIPTION OF THE DRAWINGS

The preferred embodiments of the invention will be described in detail, with reference to the following figures, wherein:

FIG. 1 shows a process for manufacturing an insulation product including a mixed layer of textile glass fibers and of rotary and/or flame attenuated glass fibers.

### DETAILED DESCRIPTION OF PREFERRED EMBODIMENTS

The fiber insulation product of the present invention includes a mixed layer of textile fibers and of rotary and/or flame attenuated fibers.

The fibers in the mixed fiber layer can form a nonwoven porous structure. The nonwoven fibers can be in the form of a batt, mat, blanket or board. The textile fibers and the rotary and/or flame attenuated fibers intermingle in the mixed layer. Preferably, the mixed layer is a uniform mixture of the textile fibers and of the rotary and/or flame attenuated fibers.

The fibers in the mixed layer can be organic or inorganic. Suitable organic fibers include cellulosic polymer fibers, such as rayon; and thermoplastic polymer fibers, such as polyester or nylon. Preferably, the fibers are inorganic. Inorganic fibers include rock wool and glass wool.

Preferably, the fibers are inorganic and comprise a glass. The glass can be, for example, an E-glass, a C-glass, or a high boron content C-glass.

In embodiments, each of the textile and the rotary and/or flame attenuated fibers can be made of the same material. In other embodiments, the textile fibers can be made from one material, and the rotary and/or flame attenuated fibers can be made from a different material. In still other embodiments, different textile fibers can each be made from different materials; and different rotary or flame attenuated glass fibers can be made from different materials. Cost and insulation requirements will dictate the selection of the particular materials used in the textile, rotary and flame attenuated fibers. Preferably, the textile fibers are formed from starch coated or plastic coated E-glass and the rotary and flame attenuated fibers are formed from high boron C-glass.

Textile, rotary and flame attenuated fibers can be made in various ways known in the art. For example, textile fibers can be formed in continuous processes in which molten glass or polymer is extruded and drawn from apertures to lengths on the order of one mile. For use in insulation, the long textile fibers are divided into short segments by cutting techniques known in the art. Rotary fibers can be made or spun by using centrifugal force to extrude molten glass or polymer through small openings in the sidewall of a rotating spinner. Flame attenuated fibers can be formed by extruding molten glass or polymer from apertures and then blowing the extruded strands at right angles with a high velocity gas burner to remelt and reform the extruded material as small fibers.

The textile fibers used in the insulation product of the present invention have diameters of from greater than 5 μm to about 16 μm. Preferably the textile fibers are divided into segments with lengths of about 2 cm to about 15 cm, more preferably from about 6 cm to about 14 cm. The rotary and flame attenuated fibers have diameters of from about 2 μm to 5 μm. Preferably the rotary and flame attenuated fibers have lengths of about 1 cm to about 5 cm, more preferably from about 2 cm to about 4 cm.

The mixed layer of textile fibers and of rotary and/or flame attenuated fibers according to the present invention can be manufactured in a variety of ways. For example, the mixed layer can be formed by dividing long textile fibers into textile fiber segments, mixing the textile fiber segments with rotary and/or flame attenuated fibers, and depositing the mixed fibers and fiber segments on a surface. The surface can be stationary or moving. Preferably, the surface is provided by a moving conveyor or forming belt. The textile fibers can be divided in various ways known in the art, such as chopping textile fibers between two surfaces.

A particularly efficient means of forming the mixed layer involves passing pre-opened fiber nodules of textile fibers and a fibrous mat of rotary and/or flame attenuated fibers together through an apparatus configured to divide the fibers. The fibrous materials can each be either woven or non-woven, but are preferably non-woven. The fibrous mats of rotary and/or flame attenuated fibers can be specially manufactured and/or can include production scrap. In embodiments, only the textile fibers are divided in the fiber dividing apparatus. In other embodiments, both the textile fibers and the rotary and/or flame attenuated fibers are divided in the fiber dividing apparatus. An example of a fiber dividing apparatus is a tearing distribution system in which fibers are torn into fiber segments between interdigitated bars. Another example of such an apparatus is the combination of the above apparatus for rotary mat tearing and a cutting system in which textile fiber is cut by knives into fiber segments. Still another such apparatus is a sucking or depression forming hood. Divided textile and rotary and/or flame attenuated fibers passing through the apparatus are deposited onto a surface to form a mixed layer of textile fiber segments and of rotary and/or flame attenuated fibers. Preferably, the surface is provided by a moving conveyor or forming belt. The mixed layer can be in the form of a fibrous batt, mat, blanket, or board.

A binder can be used to capture and hold the fibers in the mixed layer together. The binder can be organic or inorganic. The binder can be a thermosetting polymer, a thermoplastic polymer, or a combination of both thermoplastic and thermosetting-polymers. Preferably, the thermosetting polymer is a phenolic resin, such as a phenol-formaldehyde resin, which will cure or set upon heating. The thermoplastic polymer will soften or flow upon heating above a temperature such as the melting point of the polymer. The heated binder will join and bond the fibers. Upon cooling and hardening, the binder will hold the fibers together. When binder is used in the insulation product, the amount of binder can be from 1 to 30 wt %, preferably from 3 to 25 wt %, more preferably from 4 to 24 wt %. The binder can be added to and mixed with the fibers before or after the fibers are divided into small segments.

In embodiments, the thickness of the mixed layer of the insulation product of the present invention is preferably in a range from 10 to 150 mm, more preferably from 20 to 100 mm, most preferably from 25 to 52 mm. The percentage of textile fiber in the product can be in a range of 1 to 99%, preferably from 20% to 70% and more preferably from 25% to 50%. The higher the percentage of textile fiber, the stronger the product. However, higher percentages of textile fiber lead to a reduction in acoustic and thermal insulation performance with high cost.

### EXAMPLE

The following non-limiting example will further illustrate the invention.

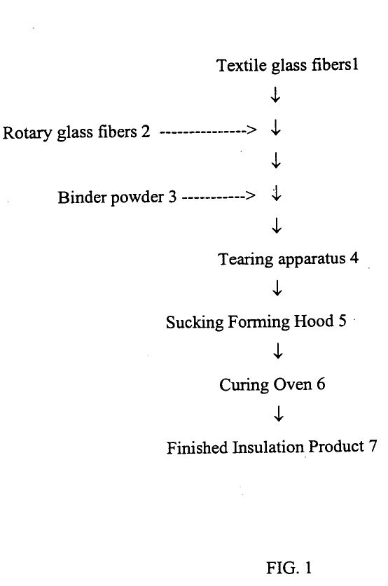

FIG. 1 illustrates various embodiments of the invention. A bale of textile glass fibers is opened (not shown) and opened textile glass fibers 1 are deposited onto a conveyor (not shown). A mat of rotary glass fibers 2 is combined with the opened textile glass fibers 1. A binder powder 3 is then added to the combined rotary and textile fibers. The rotary fibers 2, textile fibers 1 and binder powder 3 then enter a tearing apparatus 4 where the textile and the rotary glass fibers are divided into small segments and mixed together to form a mixture of short fibers. The mixture of short fibers, along with the binder powder 3, form a uniform rotary/textile fiber primary mat at the outlet of the sucking forming hood 5. When the primary mat passes through curing oven 6, the binder powder 3 flows to fix the fibers and form the finished insulation product 7.

Table 1 compares tested R-values-(index of thermal insulation) and NRC-values (noise reduction coefficient) for a layer made of only textile fibers and a uniform layer of rotary (30%) and textile (70%) fibers. The textile fibers are made from E-glass and the rotary are made from C-glass.

TABLE 1

| Duct-liner Product: | | | |
|---|---|---|---|
| 1.5 pounds per cubic | | | |
| foot, 2.54 cm thick | R-value | NRC | Parting Strength |
| Layer of Textile Fibers | 3.6 | 0.60 | 5.0 (std deviation = 0.6) |
| only | | | |
| Uniform layer of Rotary | 3.8 | 0.60-0.65 | 4.1 (std deviation = 0.2) |
| (30%) and of Textile | | | |
| (70%) Fibers | | | |

Table 1 shows that a uniform layer of rotary fibers and of textile fibers provides a higher R-value and a higher NRC value than a layer of only textile fibers, with slightly lower tensile strength but greater uniformity as represented by a lower standard deviation.

While the present invention has been described with respect to specific embodiments, it is not confined to the specific details set forth, but includes various changes and modifications that may suggest themselves to those skilled in the art, all falling within the scope of the invention as defined by the following claims.

1-23. (canceled)

24. A duct liner, comprising:
a layer comprising a uniform mixture of first fibers and second fibers,
wherein the first fibers are inorganic fibers having a diameter from 2 μm to 5 μm,
the second fibers are glass textile fibers having a diameter of from greater than 5 μm to 16 μm, and
the first fibers and the second fibers intermingle in the layer.

25. The duct liner according to claim 24, wherein the first fibers are rotary scrap fibers.

26. The duct liner according to claim 24, wherein the layer consists of the first fibers, the second fibers, and a binder.

27. The duct liner according to claim 24, wherein the first fibers have a length of from 1 cm to 5 cm and the second fibers have a length of from 2 cm to 15 cm.

28. The duct liner according to claim 24, wherein the mixture farther comprises a binder.

29. The duct liner according to claim 28, wherein the binder is present in an amount of from 3 to 25 wt %.

30. The duct liner according to claim 28, wherein the binder comprises an organic polymer.

31. The duct liner according to claim 24, having a noise reduction coefficient of from 0.6 to 0.65 at a thickness of 2.54 cm and a density of 1.5 lb/ft³.

32. The duct liner according to claim 24, wherein the first fibers and second fibers each comprise at least one glass independently selected from the group consisting of an E-glass, a C-glass, and a boron doped C-glass.

33. The duct liner according to claim 24, wherein the second fibers are starch coated textile fibers.

34. The duct liner according to claim 24, wherein the first fibers have a length of from 1 cm to 4 cm and the second fibers have a length of from 6 cm to 14 cm.

35. The duct liner according to claim 24, wherein the second fibers are present in an amount of 25 to 50%.

36. The duct liner according to claim 24, wherein the second fibers are present in an amount of from 20 to 70%.

37. The duct liner according to claim 24, wherein the first fibers are C-glass fibers and the second fibers are E-glass fibers.

38. The duct liner according to claim 24, wherein the first fibers have a length of less than 4 cm.

39. The duct liner according to claim 24, prepared by mixing the first fibers and second fibers in a dry process.

40. A thermal and acoustical insulator, comprising:
a layer comprising a uniform mixture of first fibers and second fibers,
wherein the first fibers are inorganic fibers having a diameter from 2 μm to 5 μm,
the second fibers are glass textile fibers having a diameter of from greater than 5 μm to 16 μm, and
the first fibers and the second fibers intermingle in the layer.

41. The thermal and acoustical insulator according to claim 40, wherein the first fibers are rotary scrap fibers.

42. The thermal and acoustical insulator according to claim 40, wherein the layer consists of the first fibers, the second fibers, and a binder.

43. The thermal and acoustical insulator according to claim 40, wherein the first fibers have a length of from 1 cm to 5 cm and the second fibers have a length of from 2 cm to 15 cm.

44. The thermal and acoustical insulator according to claim 40, wherein the mixture further comprises a binder.

45. The thermal and acoustical insulator according to claim 44, wherein the binder is present in an amount of from 3 to 25 wt %.

46. The thermal and acoustical insulator according to claim 44, wherein the binder comprises an organic polymer.

47. The thermal and acoustical insulator according to claim 40, having a noise reduction coefficient of from 0.6 to 0.65 at a thickness of 2.54 cm and a density of 1.5 lb/ft³.

48. The thermal and acoustical insulator according to claim 40, wherein the first fibers and second fibers each comprise at least one glass independently selected from the group consisting of an E-glass, a C-glass, and a boron doped C-glass.

49. The thermal and acoustical insulator according to claim 40, wherein the second fibers are starch coated textile fibers.

50. The thermal and acoustical insulator according to claim 40, wherein the first fibers have a length of from 1 cm to 4 cm and the second fibers have a length of from 6 cm to 14 cm.

51. The thermal and acoustical insulator according to claim 40, wherein the second fibers are present in an amount of 25 to 50%.

52. The thermal and acoustical insulator according to claim 40, wherein the second fibers are present in an amount of from 20 to 70%.

53. The thermal and acoustical insulator according to claim 40, wherein the first fibers are C-glass fibers and the second fibers are E-glass fibers.

54. The thermal and acoustical insulator according to claim 40, wherein the first fibers have a length of less than 4 cm.

55. The thermal and acoustical insulator according to claim 40, prepared by mixing the first fibers and second fibers in a dry process.

56. The duct liner according to claim 24, wherein the mixture further comprises a binder, the first fibers are rotary fibers and the second fibers are present in an amount of from 50 to 70%.

57. The thermal and acoustical insulator according to claim 40, wherein the mixture further comprises a binder, the first fibers are rotary fibers and the second fibers are present in an amount of from 50 to 70%.

58. The duct liner according to claim 24, wherein the first fibers are rotary fibers.

59. The thermal and acoustical insulator according to claim 40, wherein the first fibers are rotary fibers.
